(19) United States
(12) Patent Application Publication
(10) Pub. No.: US 2010/0306063 A1
(43) Pub. Date: Dec. 2, 2010

(54) Method and Apparatus for Generating Advertisement

(75) Inventors: Hui Wang, Shenzhen (CN); Kai Xie, Shenzhen (CN)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: Tencent Technology (Shenzhen) Company Ltd., Shenzhen (CN)

(21) Appl. No.: 12/675,772

(22) PCT Filed: Aug. 20, 2008
(86) PCT No.: PCT/CN08/72063

§ 371 Date: Feb. 26, 2010

(30) Foreign Application Priority Data
Sep. 28, 2007 (CN) 200710123777.7

(51) Int. Cl. G06Q 30/00

(52) U.S. Cl. 705/14.69; 705/14.72

(57) ABSTRACT

Disclosed is a method and apparatus for generating an advertisement. The method includes: decomposing contents of an advertisement into advertisement elements; selecting at least one skin element from a skin of a system; combining the advertisement elements and the at least one skin element to generate an advertisement skin; and taking the advertisement skin as a new skin of the system. The apparatus includes: an initialization module, adapted to decompose contents of an advertisement into advertisement elements and select at least one skin element from a skin of a system; and a combining module, adapted to combine the advertisement elements and the at least one skin element to generate an advertisement skin, and take the advertisement skin as a new skin of the system.

This application claims the priority of Chinese Patent Serial No. 200710123777.7, entitled “method and apparatus for generating advertisement”, filed on Sep. 28, 2007, the whole content of which is incorporated herein by reference.

### FIELD OF THE INVENTION

The present invention relates to network communication technologies, and more particularly, to a method and apparatus for generating an advertisement.

### BACKGROUND OF THE INVENTION

Most familiar advertisements on the Internet are images (static or dynamic) and texts which are located in a prominent and visible position on a webpage. They attract people's eyes through their contents so as to make people click on or look at the advertisements. Generally, advertisement fees are calculated according to a clicking ratio of the images and links.

A software skinning technique has been widely used on the Internet. Through simple selection and confirmation, pictures, color scheme, operation habits and operation styles on all webpages may be replaced at one time. Combined with the software skinning technique, an email system is provided with rich and colorful skinning effects.

In a conventional email system, a regular advertisement mode on the Internet is used. In this advertisement mode, advertisement banners are arranged in some visible areas of the webpage of the email system and advertisement fees are calculated according to clicking times of users, and areas and types of the advertisement banners. The regular advertisement mode has the following disadvantages: 1) advertisement contents and webpage contents are not associated with each other; 2) different advertisements on one webpage may have totally different styles, or even interfere with each other; 3) contents that the users wish to read normally (i.e. core contents of the webpage) are pushed to a secondary position due to the size and position of the advertisements inserted, while the images and texts of the advertisements usually occupy a main position on the webpage; the advertisement contents greatly interfere in or even destroy the webpage contents; and as a result, the users feel terrible; 4) there is no certain relationship between an advertisement effect and an increase of the clicking times of the advertisement.

For example, a dynamic advertisement floats all round the webpage and the webpage contents may thus be covered, which directly affect reading of the pictures and the texts on the webpage. When a user does not wish to read the advertisements, the user may adopt various means to shield the advertisements, which affects income of an advertisement provider. In addition, the style of the advertisement may collide with that of the webpage, which makes the advertisement completely not harmonize with the webpage. The whole effect of the webpage is greatly destroys and it is difficult for an advertisement with a smaller area to attract user's attention.

### SUMMARY OF THE INVENTION

Embodiments of the present invention provide a method and apparatus for generating an advertisement, so as to improve advertisement effect in a system.

According to one aspect of the present invention, a method for generating an advertisement is provided. The method includes: decomposing contents of an advertisement into advertisement elements; selecting at least one skin element from a skin of a system; combining the advertisement elements and the at least one skin element to generate an advertisement skin; and taking the advertisement skin as a new skin of the system.

The combining the advertisement elements and the at least one skin element to generate the advertisement skin includes: combining the advertisement elements and the at least one skin element to generate the advertisement skin according to a rule that one advertisement element appears in at least one skin element.

The method further includes: configuring a presence effect for a webpage using the advertisement skin after generating the advertisement skin.

The method further includes: configuring a function selection menu to enable a user to choose to use a no-advertisement mode or use an advertisement skin mode.

The method further includes: when a user uses the new skin, charging for the advertisement according to at least one of: attribute of the advertisement skin, attribute of the user, and operation information of the user on the new skin.

The method further includes: when a user uses the new skin, recording operation information of the user on the new skin, and providing the user with an award when a recorded value reaches a specified value.

The system is an email system.

According to another aspect of the present invention, an apparatus for generating an advertisement is provided. The apparatus includes: an initialization module, adapted to decompose contents of an advertisement into advertisement elements and select at least one skin element from a skin of a system; and a combining module, adapted to combine the advertisement elements and the at least one skin element to generate an advertisement skin, and take the advertisement skin as a new skin of the system.

The combining module includes: a configuring unit, adapted to configure a rule that one advertisement element appears in at least one skin element; and a combination unit, adapted to combine, according to the rule configured by the configuring unit, the advertisement elements and the at least one skin element from the initialization module to generate the advertisement skin, and take the advertisement skin as the new skin of the system.

The apparatus further includes: an effect-configuring module, adapted to configure a presence effect for a webpage using the advertisement skin after the combining module generates the advertisement skin.

The apparatus further includes: a menu-configuring module, adapted to configure a function selection menu to enable a user to choose to use a no-advertisement mode or use an advertisement skin mode.

The apparatus further includes: a charging module, adapted to charge, when a user uses the new skin obtained by the combining module, for the advertisement according to at least one of attribute of the new skin, attribute of the user and operation information of the user on the new skin.

The apparatus further includes: a feedback module, adapted to record, when a user uses the new skin obtained by the combining module, operation information of the user on the new skin, and provide the user with an award when a recorded value reaches a specified value.

Advantages according to the technical scheme provided by embodiments of the present invention are as follows.

The embodiments of the present invention combine the advertisement elements and the skin elements into the advertisement skin so that the advertisement and a system webpage become harmonious and have a uniform style, which brings the user an illusion that there is no advertisement. Compared with the conventional art in which advertisements are independent of each other or even collide with each other, the advertisement distribution in the embodiments of the present invention has a stereo effect and is much richer. Thus, it is easy to be accepted by the user. The annoyance caused by the advertisement to the user is avoided to some extent and the aversion of the user against the advertisement may be reduced to some extent. Therefore, the advertisement effect is enhanced and a negative affect is reduced. In addition, the skinning technique brings fresh feelings to the user, which avoids a problem that a single style cannot satisfy all users, reduces pressure on developing new versions and wins better public praise. Through the function selection menu, the user can make a choice. Thus, the apparatus and method can be applied more flexibly and can satisfy different requirements of different users. None of conventional Internet advertisement systems allows the user to make a choice. They both adopt a compulsive distribution manner to display an advertisement on a screen irrespective whether the user is interested in it or not. Therefore, through providing the user with a choice of using the no-advertisement mode, the apparatus and method in the embodiments of the present invention greatly reduce compulsive feelings of the user and win favors of the user. Furthermore, it is easier to be accepted by the two parties of the advertisement to charge according to the attribute of the advertisement skin, the attribute of the user and the operation information of the user on the advertisement skin. In addition, when the recorded operation information of the user on the new skin reaches a specified value, the user is provided with an award, which encourages the user to initiatively choose the advertisement so as to turn a passive advertisement to an initiative advertisement. Consequently, the advertisement may have a long time effect. Further, as time goes by, an advertisement provider can receive a permanent advertisement effect and the system can also obtain durative and stable income.

### BRIEF DESCRIPTION OF THE DRAWINGS

FIG. 1 is a schematic diagram illustrating a structure of an apparatus for generating an advertisement according to a first embodiment of the present invention.

FIG. 2 is a flow chart of a method for generating an advertisement according to a second embodiment of the present invention.

### DETAILED DESCRIPTION OF THE INVENTION

The present invention will be described in detail hereinafter with reference to accompanying drawings and embodiments to make the solution and merits therein clearer.

In embodiments of the present invention, the system refers to a system having a skin in network communications. There are various such systems, e.g. a website system, an email system, etc.

### A First Embodiment

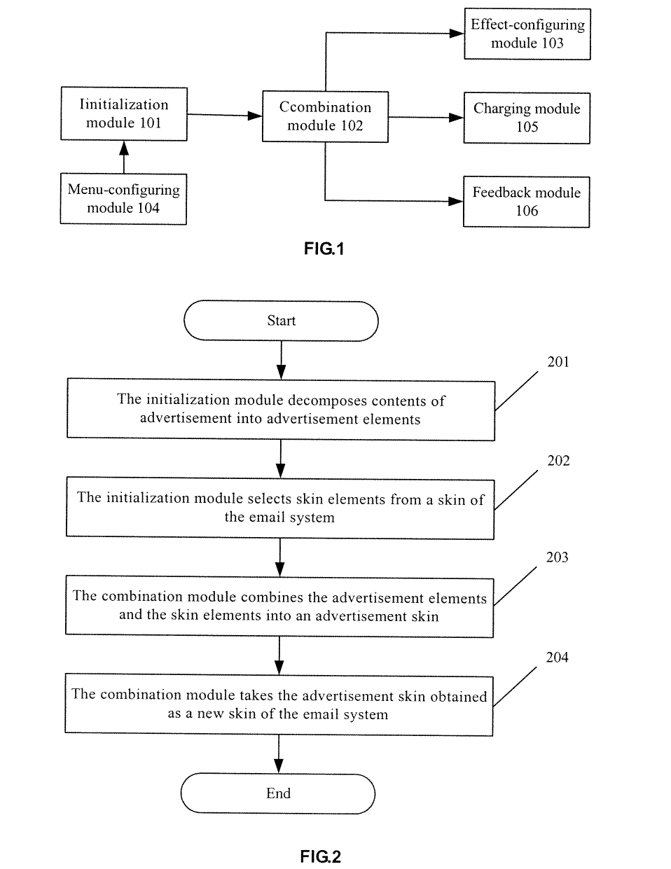

As shown in FIG. 1, an apparatus for generating an advertisement according to an embodiment of the present invention includes: an initialization module 101 and a combining module 102.

The initialization module 101 is adapted to decompose contents of an advertisement into advertisement elements and select skin elements from a skin of the system.

The advertisement elements may include: figure, text, color, sound, brightness, etc. The skin elements selected from the skin of the system may be all skin elements of the skin or some skin elements of the skin. The skin element may include: background color, background music and sound effect of the webpage; display effect of the webpage, color-scheme and type style of table; and font, color and type style of text on the webpage.

The combining module 102 is adapted to combine the advertisement elements and the skin elements obtained by the initialization module 101 to generate an advertisement skin, and take the advertisement skin as a new skin of the system.

There may be various combination rules. It may be configured according to requirements. The advertisement elements and the skin elements may be directly combined, or be modified and changed during the combination so as to achieve a better combination effect.

After the combination, one advertisement element may appear in one skin element or appear in multiple skin elements simultaneously. One skin element may contain one or more advertisement elements or contain no advertisement element.

The combining module 102 may include:

a configuring unit, adapted to configure a rule that one advertisement element appears in at least one skin element; and

a combination unit, adapted to combine, according to the rule configured by the configuring unit, the advertisement elements and the skin elements obtained by the initialization module 101 to generate the advertisement skin, and take the advertisement skin as the new skin of the system.

In addition, the apparatus for generating the advertisement may further include:

an effect-configuring module 103, adapted to configure a presence effect for a webpage using the advertisement skin after the combining module generates the advertisement skin.

The presence effect includes: accompanying sound, appearing direction, appearing speed and appearing mode while the webpage appears. With respect to each advertisement skin, there may be multiple corresponding webpages. Through configuring a presence effect for each webpage, a user can feel change of various scenes when using the system and the advertisement effect is enhanced. Furthermore, while configuring the presence effect, corresponding relationships between the webpage and the presence effect may be adjusted according to general use habits of the system and practical use habits of the user. For example, a system homepage or a webpage that the user usually visits may be configured with a more prominent presence effect.

Furthermore, the apparatus may further include:

a menu-configuring module 104, adapted to configure a function selection menu to enable the user to choose to use a no-advertisement mode or use an advertisement skin mode.

The no-advertisement mode means that the system does not contain any advertisement. Through the function selection menu, the user can choose to use the no-advertisement mode or use the advertisement skin mode mentioned above. In addition, conventional advertisement modes may remain in the new skin. It is not excluded that a conventional advertisement may appear in a particular position of the new skin. For example, it is possible to distribute a special face, or a letter pad, etc.

In addition, the apparatus may further include:

a charging module 105, adapted to charge, when the user uses the new skin obtained by the combining module 102, for the advertisement according to at least one of: attribute of the new skin, attribute of the user and operation information of the user on the new skin.

The new skin may have various attributes, including: number of words, font size, color, number of colors, area of colors, type of the advertisement elements, display area of figure, and presence positions of the figure and text, etc. The attribute of the user include many types of information such as the user's grade. The operation information of the user on the new skin also includes various information, such as the time that the user uses the new skin or the advertisement elements, the number of times that the user uses the new skin or the advertisement elements, the number of times that the advertisement elements are transmitted, and the number of times that the new skin is recommended and successfully adopted. When charging an advertisement distributor for the advertisement, it is possible to accumulate fees after the user starts to use the new skin and charge advertisement distributor at regular times. Preferably, the accumulation may have an upper limit or not.

In addition, the apparatus may further include:

a feedback module 106, adapted to record, when the user uses the new skin obtained by the combining module 102, the operation information of the user on the new skin, and provide the user with an award when a recorded value reaches a specified value.

The specified value may be, for example, a period of 20 hours for using the new skin. There may be various modes for providing the user with the award, including: providing an additional function, a particular function, a gift and a service, etc. For example, it is possible to provide virtual coins to the user, or increase a storage space of the user pro rata, or increase the user's grade, so as to enable the user to transmit a super-large email, etc.

### A Second Embodiment

In this embodiment, the email system is taken as an example. As shown in FIG. 2, embodiments of the present invention provide a method for generating an advertisement, including the following steps.

Step 201: An initialization module decomposes contents of an advertisement into advertisement elements.

The advertisement is an advertisement to be distributed. The contents expressed by the advertisement are decomposed into the advertisement elements, wherein the advertisement elements may include figure, text, color, sound and brightness, etc.

Step 202: The initialization module selects skin elements from a skin of the email system.

The skin of the email system is a conventional skin. Different skins have different webpage styles. The skin elements selected from the skin of the email system may be all skin elements of the skin or some skin elements of the skin. The skin elements include, but are not limited to, the following:

1) background color, background music, sound effect of a webpage;

2) display effect, color-scheme and type style of tables on the webpage;

3) font, color, type style of texts on the webpage;

4) position of the webpage in a directory of the email system;

5) presence mode, size and display effect (dynamic or static) of images in the webpage;

6) operation mode and accompanying sound effect of operable element in the webpage, e.g. operations of a text input area and a multiple-choice selection, and effects after they are selected;

7) harmonizing mode of pictures and colors in different webpages in case of multiple webpages are displayed in a combination mode (e.g. frame mode);

8) letter pad and font used when reading, replying to or writing an email;

9) presence mode of an address list, display mode of contact information, selection mode of contacts.

Step 203: The combining module combines the advertisement elements and the skin elements into an advertisement skin.

There may be various combination rules, which may be configured according to requirements. For example, it is possible to configure that one advertisement element appears in at least one skin element. Thus, the advertisement elements and the skin elements may be combined into the advertisement skin according to the rule.

During the combination, the advertisement elements and the skin elements may be directly combined or be modified and changed during the combination so as to achieve a better combination effect. For example, suppose that an advertisement is decomposed into four main elements A, B, C and D, wherein the elements A, B, C and D may be text, sound, image or video segment that attract attention of users. Further, suppose that five main elements a, b, c, d and e are selected from skin elements of an email system. Thus, a process of combining the above advertisement elements and the above skin elements may be any permutation and combination of the advertisement elements A, B, C and D and the skin elements a, b, c, d and e. For example, respectively combine A with a, B with b, C with c and d, D with e. Further, the advertisement elements or the skin elements may be modified or changed. For example, the advertisement element A is a picture and the skin element a is the size of a picture in a certain position on the webpage. If the size of the picture A is not suitable for the size a, the picture A may be zoomed in or out to be adapted to the size a. The modification and change include, but are not limited to, adjusting of text type, color, and display sequence of image or video.

After the combination, one advertisement element may appear in one skin element or in multiple skin elements simultaneously. One skin element may contain one or multiple advertisement elements or contain no advertisement element.

For example, with respect to a cola product, a skin may be customized according to advertisement elements including typical color and logo of the product. In a webpage using the advertisement skin, an email list, an address list and the like should have the typical color and logo of the cola product, and a sound effect is also consistent with the style of the cola product.

Step 204: The combining module takes the advertisement skin obtained as a new skin of the email system.

The advertisement skin obtained has contained the advertisement elements. And contents of the advertisement have been presented in the advertisement skin. Thus, the advertisement skin may be regarded as an advertisement. The process of taking the advertisement skin as the new skin of the email system may be regarded as the process of distributing the generated advertisement through the new skin of the email system.

In addition, the method may further include:

configuring, by an effect-configuring module, a presence effect for the webpage using the advertisement skin after the combining module generates the advertisement skin.

The presence effect includes effects of accompanying sound, appearing direction, appearing speed and appearing mode while the webpage appears. With respect to each advertisement skin, there may be multiple corresponding webpages and each webpage is configured with a presence effect, so that a user can feel change of various scenes when using the email system and the advertisement effect is thus enhanced. Furthermore, while configuring the presence effect, corresponding relationships between the webpage and the presence effect may be adjusted according to general use habits of the email system and practical use habits of the user. For example, the email system homepage or a webpage that the user usually visits may be configured with a more prominent presence effect.

In order to improve compatibility of the email system, the method may further include:

configuring, by a menu-configuring module, a function selection menu to enable the user to choose a no-advertisement mode or an advertisement skin mode.

The no-advertisement mode means that the email system does not contain any advertisement. When the user chooses to use the no-advertisement mode through the function selection menu, the email system provides the user with the webpage which does not contain any advertisement. When the user chooses to use the advertisement skin mode through the function selection menu, the email system provides the user with different types of advertisement skins, and the user can choose a desirable advertisement skin according to his/her interest.

In addition, conventional advertisement modes may remain in the new skin. It is not excluded that a conventional advertisement may appear in a particular position of the new skin. For example, it is possible to distribute a special face, or a letter pad, etc.

In addition, the method may further include a charging step, i.e., when the user uses the new skin, a charging module charges for the advertisement according to at least one of: attribute of the new skin, attribute of the user and operation information of the user on the new skin.

The new skin may have various attributes, including, but are not limited to the following:

1) number of words, font size, color, number of colors, area of colors, etc.;

2) the type of an advertisement element, e.g. letter pad, business card, face symbol, greeting card, and signature, etc.;

3) display area of figure;

4) presence positions of the figure and text (e.g., homepage background, tips window, letter pad, address list, etc.)

5) maintenance time of particular text and figure;

6) ranking of new skins on a selection interface.

The attribute of the user includes information such as the user's grade, e.g. a common user, an advanced user, etc.

The operation information of the user on the new skin is also various, including but is not limited to:

1) the time that the user uses the new skin or the advertisement elements;

2) number of times that the user uses the new skin or the advertisement elements;

3) number of times that the advertisement elements is transmitted;

4) number of times that the new skin is recommended and successfully adopted;

5) number of times that the new skin is selected regressively. For example, a user selects skin A initially, and then selects skin B, but finally selects skin A. This process is regarded as a valid regress.

When charging an advertisement distributor for the advertisement, it is possible to accumulate fees after the user starts to use the new skin and charge advertisement distributor at regular times. Preferably, the accumulation may have an upper limit or not.

For example, if the number of times that the user transmits emails using the letter pad of the new skin reaches 10000, n units of fees are charged for the advertisement. Or, if the user uses the mailbox background color of the new skin for more than 10000 hours, n units of fees will be charged for the advertisement. Or, if the new skin has been ranked in the first on a selection interface for one month, n units of fees will be charged for the advertisement. The ranking of free advertisements will change along with the user's usage ratio.

In addition, the above charging rules may be integrated to generate a charging formula. According to the charging formula, a whole charging result is calculated.

In order to encourage the user to initiatively select the new skin of the email system, the method may further include:

when the user uses the new skin, recording, by a feedback module, the operation information of the user on the new skin, and providing the user with an award when a recorded value reaches a specified value.

The specified value may be, for example, a period of 20 hours for using the new skin, or 10 times for using the new skin, etc.

The operation information of the user on the new skin has been described above and will not be repeated herein. There may be various modes for providing the user with the award, including: providing an additional function, a particular function, a gift and a service, etc. For example, it is possible to provide virtual coins, a physical gift or a service to the user, or increase pro rata a storage space of the user, number of emails can be transmitted by the user, number of friends to which information can be transmitted by the user, or increase the user's grade, or provide the user with a special email reminder notification, so as to enable the user to transmit a super-large email, etc.

The embodiments of the present invention combine the advertisement elements and the skin elements into the advertisement skin so that the advertisement and a system webpage become harmonious and have a uniform style, which brings the user an illusion that there is no advertisement. Compared with the conventional art in which advertisements are independent of each other or even collide with each other, the advertisement distribution in the embodiments of the present invention has a stereo effect and is much richer. Thus, it is easy to be accepted by the user. The annoyance caused by the advertisement to the user is avoided to some extent and the aversion of the user against the advertisement may be reduced to some extent. Therefore, the advertisement effect is enhanced and a negative affect is reduced. In addition, the skinning technique brings fresh feelings to the user, which avoids a problem that a single style cannot satisfy all users, reduces pressure on developing new versions and wins better public praise. Through the function selection menu, the user can make a choice. Thus, the apparatus and method can be applied more flexibly and can satisfy different requirements of different users. None of conventional Internet advertisement systems allows the user to make a choice. They both adopt a compulsive distribution manner to display an advertisement on a screen irrespective whether the user is interested in it or not. Therefore, through providing the user with a choice of using the non-advertisement mode, the apparatus and method in the embodiments of the present invention greatly reduce compulsive feelings of the user and win favors of the user. Furthermore, it is easier to be accepted by the two parties of the advertisement to charge according to the attribute of the advertisement skin, the attribute of the user and the operation information of the user on the advertisement skin. In addition, when the recorded operation information of the user on the new skin reaches a specified value, the user is provided with an award, which encourages the user to initiatively choose the advertisement so as to turn a passive advertisement to an initiative advertisement. Consequently, the advertisement may have a long time effect. Further, as time goes by, an advertisement provider can receive a permanent advertisement effect and the system can also obtain durative and stable income.

The foregoing is only embodiments of the present invention. The protection scope of the present invention, however, is not limited to the above description. Any change or substitution, easily occurring to those skilled in the art, should be covered by the protection scope of the present invention.

1. A method for generating an advertisement, comprising:
decomposing contents of an advertisement into advertisement elements;
selecting at least one skin element from a skin of a system;
combining the advertisement elements and the at least one skin element to generate an advertisement skin; and
taking the advertisement skin as a new skin of the system.

2. The method of claim 1, wherein the combining the advertisement elements and the at least one skin element to generate the advertisement skin comprises:
combining the advertisement elements and the at least one skin element to generate the advertisement skin according to a rule that one advertisement element appears in at least one skin element.

3. The method of claim 1, further comprising:
configuring a presence effect for a webpage using the advertisement skin after generating the advertisement skin.

4. The method of claim 1, further comprising:
configuring a function selection menu to enable a user to choose to use a no-advertisement mode or use an advertisement skin mode.

5. The method of claim 1, further comprising:
when a user uses the new skin, charging for the advertisement according to at least one of: attribute of the new skin, attribute of the user, and operation information of the user on the new skin.

6. The method of claim 1, further comprising:
when a user uses the new skin, recording operation information of the user on the new skin, and providing the user with an award when a recorded value reaches a specified value.

7. The method of claim 1, wherein the system is an email system.

8. An apparatus for generating an advertisement, comprising:
an initialization module, adapted to decompose contents of an advertisement into advertisement elements and select at least one skin element from a skin of a system; and
a combining module, adapted to combine the advertisement elements and the at least one skin element to generate an advertisement skin, and take the advertisement skin as a new skin of the system.

9. The apparatus of claim 8, wherein the combining module comprises:
a configuring unit, adapted to configure a rule that one advertisement element appears in at least one skin element; and
a combination unit, adapted to combine, according to the rule configured by the configuring unit, the advertisement elements and the at least one skin element from the initialization module to generate the advertisement skin, and take the advertisement skin as the new skin of the system.

10. The apparatus of claim 8, further comprising:
an effect-configuring module, adapted to configure a presence effect for a webpage using the advertisement skin after the combining module generates the advertisement skin.

11. The apparatus of claim 8, further comprising:
a menu-configuring module, adapted to configure a function selection menu to enable a user to choose to use a no-advertisement mode or use an advertisement skin mode.

12. The apparatus of claim 8, further comprising:
a charging module, adapted to charge, when a user uses the new skin obtained by the combining module, for the advertisement according to at least one of attribute of the new skin, attribute of the user and operation information of the user on the new skin.

13. The apparatus of claim 8, further comprising:
a feedback module, adapted to record, when a user uses the new skin obtained by the combining module, operation information of the user on the new skin, and provide the user with an award when a recorded value reaches a specified value.
